(19) United States
(12) Patent Application Publication
(10) Pub. No.: US 2011/0100316 A1
(43) Pub. Date: May 5, 2011

(54) Cylinder Head Assembly For An Internal Combustion Engine and Method of Manufacture

(75) Inventors: David L. Moore, Madison Heights, MI (US); Pui-Kei Yuen, Rochester Hills, MI (US)

(73) Assignee: GM GLOBAL TECHNOLOGY OPERATIONS, INC., Detroit, MI (US)

(21) Appl. No.: 12/612,789

(22) Filed: Nov. 5, 2009

(51) Int. Cl. F02F 1/42; B23P 11/00

(52) U.S. Cl. 123/193.5; 123/188.8; 29/888.06

(57) ABSTRACT

A cylinder head assembly for an internal combustion engine and its method of manufacture is disclosed. The cylinder head assembly includes a cylinder head having a combustion chamber and a port opening into the combustion chamber. An insert pocket is circumferentially disposed about the port and is configured to receive a valve seat therein and to define a seam therebetween. A seal, comprising displaced cylinder head material disposed across the seam, seals the seam against the ingress of contaminants.

### FIELD OF THE INVENTION

This invention relates to a cylinder head assembly for an internal combustion engine having a valve seat insert and, more particularly, to a cylinder head sealing assembly that resists cylinder head corrosion.

### BACKGROUND

Valve seat inserts may be installed in the cylinder heads of internal combustion engines to improve durability. Such inserts are often employed in cylinder heads comprised of softer and lighter alloys which may not have the robust strength, hardness, wear and other material characteristics required for high temperature, high wear environments. The valve seat inserts are typically press-fitted into a valve seat insert pocket in the cylinder head and are often manufactured from a relatively hard, wear-resistant and heat-resistant material such as a cast or sintered metal. When installed in the cylinder head, the valve seat inserts are effective to provide a durable seating surface for the engine's reciprocating valves.

The press-fit mating of the valve seat insert with the cylinder head valve seat insert pocket results in the formation of a seam at the interface of the valve seat insert and the cylinder head material. During operation of the engine, liquids and vapors, including fuel, water or other contaminants, may permeate the seam and become trapped between the surface of the valve seat insert and the cylinder head valve seat insert pocket. While the trapped liquids or vapors are relatively benign in engines which operate on fuels containing a relatively low percentage of alcohols, they may be corrosive in engines operating on fuels containing a relatively high percentage of alcohols, or that may include other corrosive contaminants and components. Such corrosion may be more prevalent in situations in which the cylinder head is constructed of an aluminum alloy or other light weight, alloyed materials.

In engines which utilize fuels containing a relatively high percentage of alcohol (e.g. greater than 15% ethanol/methanol), the trapped fuel, ambient water dissolved in the fuel, vapors or all of them, may form or promote the formation of corrosive acids or byproducts, which may corrode the cylinder head, the valve seat inserts, or both, in the areas associated with the valve seat inserts. Further, these components may promote dissimilar metal corrosion through a galvanic effect by serving as an electrolyte in contact with the dissimilar metals of the insert and cylinder head. It is also suspected that galvanic corrosion may occur between the dissimilar metal elements on a surface that is in contact with an electrolyte such as, for instance, the copper-aluminum (Cu-Al) interface in common aluminum alloys. Over time, such corrosion may affect the durability of the cylinder head and associated valve seat inserts, especially in cylinder heads which are manufactured from aluminum alloys.

Various methods have been proposed to address corrosion associated with fuels that contain alcohol including coating the cylinder head valve seat insert pocket with epoxy or phenolic sealants prior to installation of the valve seat insert. Such materials however, if misapplied to other components of the engine or valves during application or combusted during operation of the engine, may present potential contamination issues for devices such as oxygen sensors or other environmental devices and, therefore, must be applied with great care and precision during manufacture of the cylinder head assembly or, should be avoided. Special seals and gaskets have also been proposed; however, these devices may be costly and difficult to handle efficiently in a manufacturing environment.

It is therefore desirable to provide a valve seat insert and cylinder head sealing assembly that avoids corrosive activity, especially corrosion, which may be caused by, or associated with, fuels containing alcohols such as ethanol and methanol, and that may also include water and other corrosive components.

### SUMMARY OF THE INVENTION

In one exemplary embodiment of the present invention, a cylinder head assembly for an internal combustion engine comprises a cylinder head having a combustion chamber and a port opening into the combustion chamber. An insert pocket is circumferentially disposed about the port and is configured to receive a valve seat therein and to define a seam therebetween. A seal, comprising displaced cylinder head material disposed across the seam, seals the seam against the ingress of contaminants.

In another embodiment of the invention, a method for manufacturing a cylinder head assembly for an internal combustion engine including a cylinder head casting having a port opening into a combustion chamber is provided. The method comprises forming an insert pocket circumferentially about the port opening, press-fitting a valve seat into the insert pocket to thereby define a seam between the insert pocket and the valve seat, and displacing material from the cylinder head casting, adjacent to the seam, over the seam to form a seal.

In yet another embodiment of the invention, an internal combustion engine configured to operate on fuels containing alcohol is provided. The internal combustion engine comprises a cylinder head having a combustion chamber and a port opening into the combustion chamber. An insert pocket is circumferentially disposed about the port and is configured to receive a valve seat therein and to define a seam therebetween. A seal comprising displaced cylinder head material is disposed across the seam to seal the seam against the ingress of contaminants from the fuels containing alcohol

The above features and advantages and other features and advantages of the present invention are readily apparent from the following detailed description of the best modes for carrying out the invention when taken in connection with the accompanying drawings.

### BRIEF DESCRIPTION OF THE DRAWINGS

Other objects features, advantages and details appear, by way of example only, in the following detailed description of embodiments, the detailed description referring to the drawings in which:

FIG. 1 is a partial plan view of an exemplary embodiment of a combustion chamber of a cylinder head assembly for an internal combustion engine embodying features of the present invention;

FIG. 2 is a partial sectional view of the cylinder head taken along section 2-2 of FIG. 1;

FIG. 3 is an enlarged, partial sectional view of FIG. 2 that schematically illustrates an exemplary embodiment of a method of manufacturing a cylinder head assembly for an internal combustion engine; and

FIG. 4 is an enlarged, partial sectional view of FIG. 2.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features.

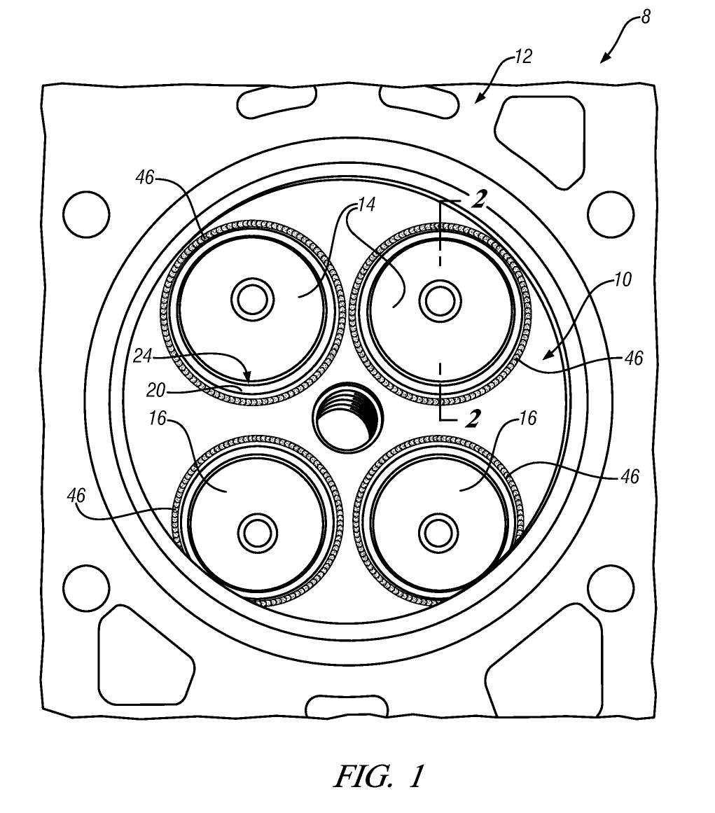

In accordance with an exemplary embodiment of the present invention, illustrated in FIG. 1, a cylinder head assembly 8, for an internal combustion engine (not shown), includes a cylinder head 12 having a combustion chamber 10. The combustion chamber 10 may comprise a number of various configurations (e.g., hemispherical) depending, in large part, on the particular engine, fuel system, or both, configuration. For the purposes of this description, the combustion chamber 10 may include any contemplated configuration. The cylinder head 12 includes one or more intake ports 14 through which a fuel/air mixture is introduced into the combustion chamber 10 during operation of the engine. The fuel/air mixture is compressed by a reciprocating piston (not shown) and is combusted in the combustion chamber 10. The combustion event drives the reciprocation of the piston and, therefore, the engine. Exhaust ports 16 provide for the exit of the products of combustion from the combustion chamber 10.

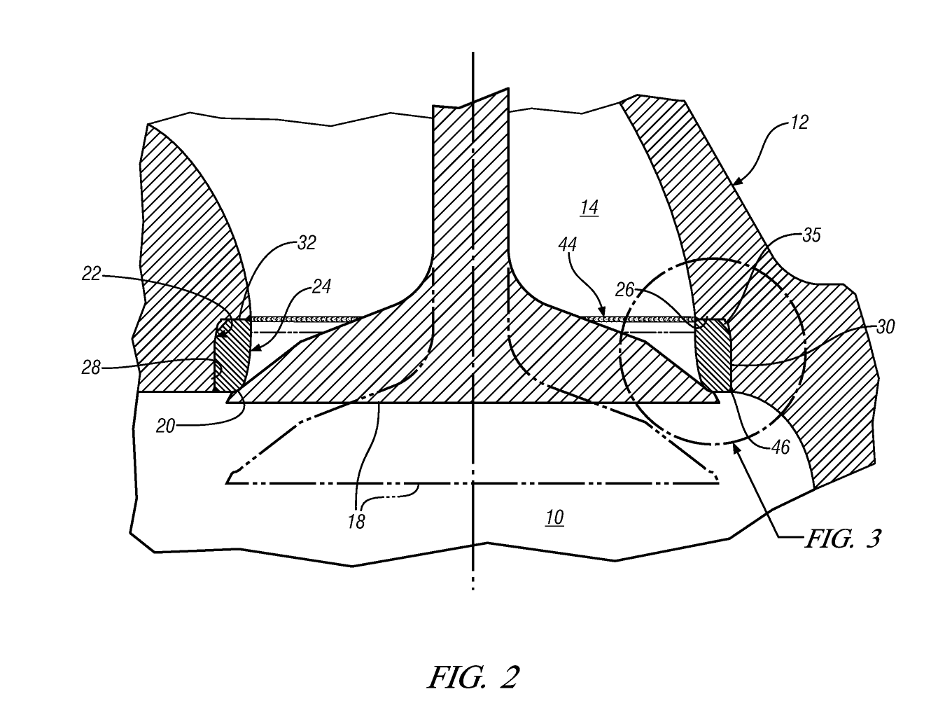

Referring to FIG. 2, a poppet valve 18 is moveably disposed within each intake port 14 of the cylinder head 12 and controls the flow of fuel, combustion air or both that enters the combustion chamber 10. The poppet valve 18 is selectively moveable from a closed position in which the valve engages a valve seat 20 to an open position (shown in phantom in FIG. 2) in which the poppet valve 18 is removed from the valve seat 20 to allow fuel, air or both, to enter the combustion chamber 10. Similar poppet valves (not shown) are disposed within each exhaust port 16 and operate in a like manner as the poppet valves 18 to allow products of combustion to exit the combustion chamber 10.

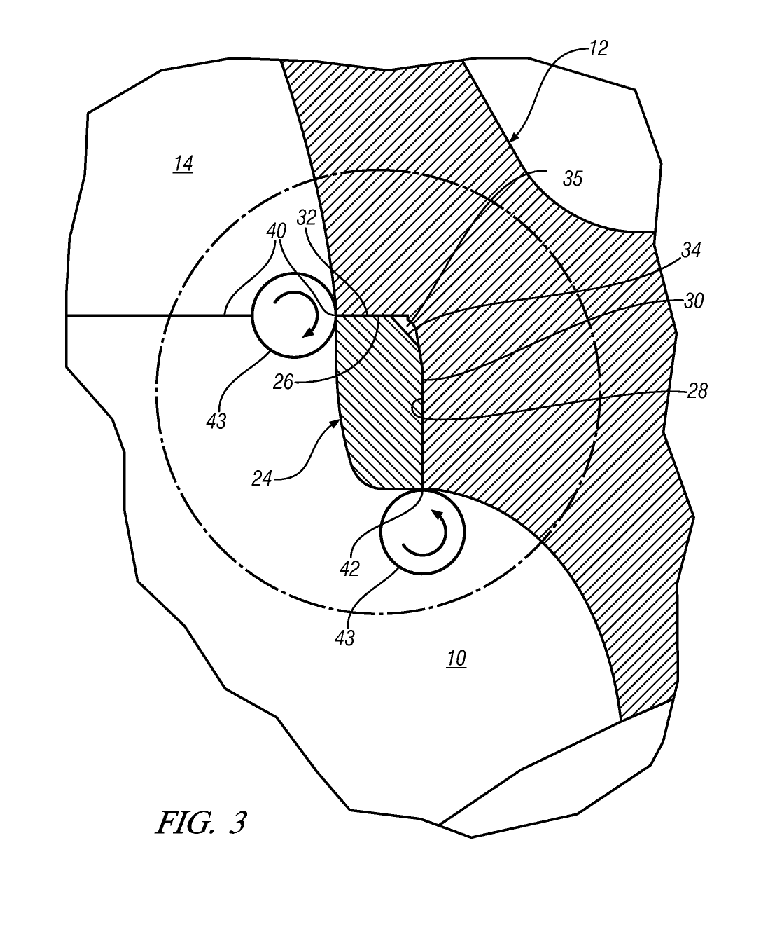

The cylinder head 12 includes integrally formed valve seat insert pockets or cavities 22 that are each configured to receive a valve seat insert 24. The valve seat insert pockets or cavities 22 may be machined into the cylinder head 12 or they may be near-net-shape cast. The valve seat insert pockets or cavities 22 are formed around, or circumscribe the intake ports 14 (and exhaust ports 16) and include an insert bearing shoulder 26 and an outer annular wall 28. Referring to FIGS. 2 and 3, a valve seat insert 24 is generally circular or ring-shaped and includes an outer annular surface 30 having a diameter which is slightly larger (on the order of about 0.7 μm) than the diameter of the outer annular wall 28 of the cylinder head valve seat insert pockets 22. The valve seat inserts 24 are typically manufactured from a relatively durable, wear-resistant and heat-treated metal material, such as hardened, heat-treated sintered powder metal, cast steel or iron. The size differential between the diameters of the cylinder head valve seat insert pockets 22 and the valve seat inserts 24 allows for interference or “press-fit” mating between the surfaces 28 and 30. Specifically, valve seat inserts 24 are press-fit into cylinder head valve seat insert pockets 22 of the cylinder head 12 in a manner that is effective to cause the outer annular surface 30 of each valve seat insert to abuttingly and frictionally engage associated annular wall 28 of each cylinder head valve seat insert pocket 22 thereby securing the valve seat insert 24 within the combustion chamber 10 of the cylinder head 12.

For ease of manufacturing the cylinder head assembly 8, the outer annular surface 30 of each valve seat insert 24 may include an angled or tapered lead-in edge portion 34. The tapered lead-in edge portion 34 aides in centering and guiding the valve seat insert 24 into a cylinder head valve seat insert pocket 22 during the press-fitting process. In some cases, due to the tapered lead-in edge portion 34, a small annular void 35 may be formed between valve seat insert 24 and the cylinder head valve seat insert pockets 22. During operation of the engine, this annular void 35 may, without proper sealing, trap various intake or exhaust materials, including, for example, debris, corrosive components, liquids (e.g., fuel, water and the like), vapors such as unburned vaporized fuel or water, or a combination thereof that exist in the combustion chamber, the intake or the exhaust ports. These materials may be transported through the interface, between the bearing shoulder 26 and the pocket seating surface 32 of valve seat insert 24 as well as through the interface between the outer annular wall 28 and the outer annular surface 30 of the valve seat insert 24. Such contamination may lead to corrosion of the cylinder head 12 especially in engines configured to operate on fuels containing alcohol

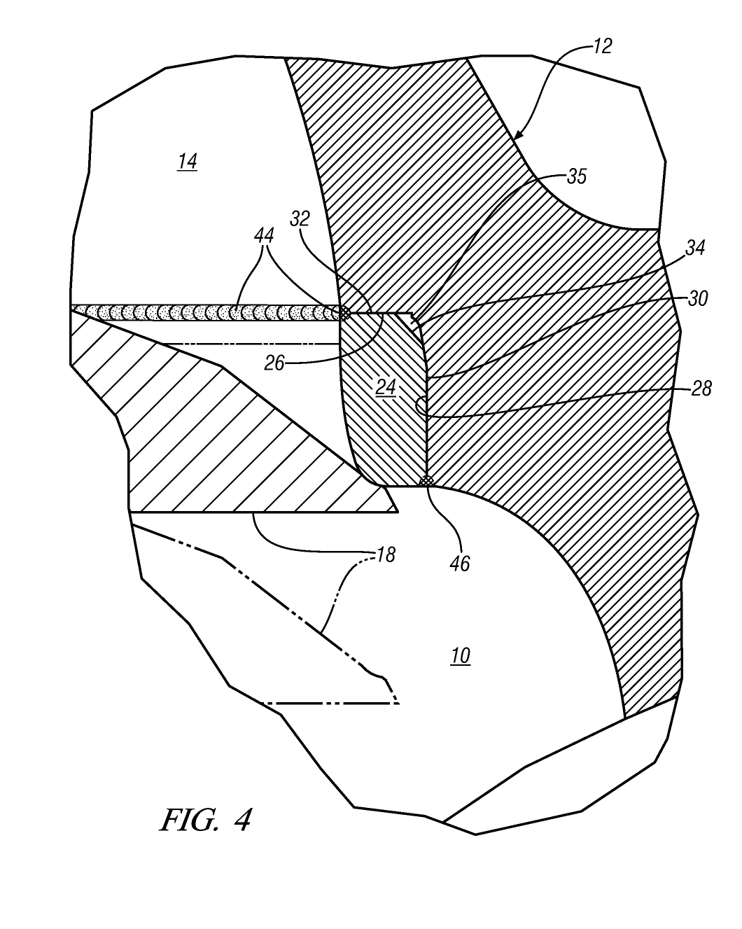

Referring to FIG. 3, the interface between the bearing shoulder 26 and the pocket seating surface 32 of valve seat insert 24 defines a seam 40 that opens into the intake port 14. Similarly, the interface between the outer annular wall 28 and the outer annular surface 30 of the valve seat insert 24 defines a seam 42 that opens into the combustion chamber 10. Both the first and the second interface seams 40, 42 respectively, extend circumferentially about the valve seat insert pockets 22 and may, without appropriate sealing, provide a mode for ingress of the contamination described. In an exemplary embodiment, following the insertion of the valve seat insert 24 into the valve seat insert pocket 22, a burnishing operation or other controlled material displacement operation is applied to the material of the cylinder head 12 that lies directly adjacent to the first and the second interface seams 40, 42 respectively, using a rotary burnishing wheel or other suitable tool 43. The operation results in a controlled displacement of cylinder head material over the first and the second seams 40, 42 that results in their closure or elimination and replacement with first and second seals 44 and 46 respectively, FIGS. 1 and 4, that comprise the deformed material. The seals 44 and 46 prevent the ingress of contaminants between the valve seat insert pockets 22 and valve seat inserts 24, effectively eliminating corrosion at their interfaces. Elimination of the first and second seams 40 dispenses with the need for expensive and difficult to apply anti-corrosion coatings on the mating surfaces of the cylinder head 12 and the valve seat inserts 14 or the use of sealing gaskets to resist the ingress of contaminants.

In another exemplary embodiment, following the insertion of the valve seat insert 24 into the valve seat insert pocket 22, a burnishing operation or other controlled material displacement operation may alternately be applied to the material of the valve seat insert 24 resulting in a controlled displacement of valve seat insert material over the first and the second seams 40, 42 that results in their closure or elimination and replacement with first and second seals 44 and 46 respectively, FIGS. 1 and 4, that comprise the deformed material. The seals 44 and 46 prevent the ingress of contaminants between the valve seat insert pockets 22 and valve seat inserts 24, effectively eliminating corrosion at their interfaces. Elimination of the first and second seams 40 dispenses with the need for expensive and difficult to apply anti-corrosion coatings on the mating surfaces of the cylinder head 12 and the valve seat inserts 14 or the use of sealing gaskets to resist the ingress of contaminants.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the present application.

What is claimed is:

1. A cylinder head assembly for an internal combustion engine, comprising:
a cylinder head having a combustion chamber;
a port opening into the combustion chamber;
an insert pocket circumferentially disposed about the port and configured to receive a valve seat therein and to define a seam therebetween; and
a seal comprising displaced cylinder head material disposed across the seam to seal the seam against the ingress of contaminants.

2. The cylinder head assembly for an internal combustion engine of claim 1, wherein the cylinder head comprises an alloyed material having a lower hardness than the valve seat and the seal comprises the alloyed material.

3. The cylinder head assembly for an internal combustion engine of claim 1, wherein the seal comprises a burnish seal.

4. The cylinder head assembly for an internal combustion engine of claim 1, wherein said seam is defined between a bearing shoulder of said insert pocket and a pocket seating surface of said valve seat insert.

5. The cylinder head assembly for an internal combustion engine of claim 1, wherein said seam is defined between an outer annular wall of said insert pocket and an outer annular surface of said valve seat insert.

6. The cylinder head assembly for an internal combustion engine of claim 1, wherein said port is an intake port.

7. The cylinder head assembly for an internal combustion engine of claim 1, wherein said port is an exhaust port.

8. A method for manufacturing a cylinder head assembly for an internal combustion engine including a cylinder head casting having a port opening into a combustion chamber comprising:
forming an insert pocket circumferentially about the port;
press-fitting a valve seat into the insert pocket to thereby define a seam between the insert pocket and the valve seat; and
displacing material from the cylinder head casting that is adjacent to the seam, over the seam to form a seal.

9. The method for manufacturing a cylinder head assembly for an internal combustion engine of claim 8, wherein the material is displaced by applying a burnishing operation applied to the cylinder head material adjacent to the intake port opening.

10. The cylinder head assembly for an internal combustion engine of claim 8, wherein said port is an intake port.

11. The cylinder head assembly for an internal combustion engine of claim 1, wherein said port is an exhaust port.

12. An internal combustion engine configured to operate on fuels containing alcohol comprising:
a cylinder head having a combustion chamber;
a port opening into the combustion chamber;
an insert pocket circumferentially disposed about the port and configured to receive a valve seat therein and to define a seam therebetween; and
a seal comprising displaced cylinder head material disposed across the seam to seal the seam against the ingress of contaminants from the fuels containing alcohol.

13. The internal combustion engine configured to operate on fuels containing alcohol of claim 12, wherein the cylinder head comprises an alloyed material having a lower hardness than the valve seat and the seal comprises the alloyed material.

14. The internal combustion engine configured to operate on fuels containing alcohol of claim 12, wherein the seal comprises a burnish seal.

15. The internal combustion engine configured to operate on fuels containing alcohol of claim 12, wherein said seam is defined between a bearing shoulder of said insert pocket and a pocket seating surface of said valve seat insert.

16. The internal combustion engine configured to operate on fuels containing alcohol of claim 12, wherein said seam is defined between an outer annular wall of said insert pocket and an outer annular surface of said valve seat insert.

17. The internal combustion engine configured to operate on fuels containing alcohol of claim 12, wherein said port is an intake port.

18. The internal combustion engine configured to operate on fuels containing alcohol of claim 12, wherein said port is an exhaust port.
